(19) United States
(12) Patent Application Publication
(10) Pub. No.: US 2025/0060261 A1
(43) Pub. Date: Feb. 20, 2025

(54) METHOD, APPARATUS, AND COMPUTER PROGRAM FOR ANALYZING CONVECTIVE HEAT TRANSFER IN HEAT EXCHANGERS

(71) Applicant: Pusan National University Industry-University Cooperation Foundation, Busan (KR)

(72) Inventors: Jae-Jun Jeong, Busan (KR); Byong-Jo Yun, Busan (KR); MINGI KIM, Busan (KR)

(21) Appl. No.: 18/792,586

(22) Filed: Aug. 2, 2024

(30) Foreign Application Priority Data
Aug. 14, 2023 (KR) 10-2023-0106474
Dec. 20, 2023 (KR) 10-2023-0186789

(51) Int. Cl. G01K 17/06; F28F 1/00

(52) U.S. Cl. CPC G01K 17/06; F28F 1/00; F28F 2200/00

(57) ABSTRACT

A method of analyzing convective heat transfer includes calculating a parameter using a centrifugal force of a fluid flowing inside a heat exchanger and analyzing convective heat transfer performed inside the heat exchanger through a relational expression using the parameter.

### CROSS-REFERENCE TO RELATED APPLICATION

This application claims the benefit of Korean Patent Application No. 10-2023-0106474, filed on Aug. 14, 2023, and Korean Patent Application No. 10-2023-0186789, filed on Dec. 20, 2023, in the Korean Intellectual Property Office, the entire disclosures of which are incorporated by reference herein for all purposes.

### BACKGROUND

### 1. Field of the Invention

The following embodiments relate to a method, an apparatus, and a computer program for analyzing convective heat transfer occurring in a heat exchanger.

### 2. Description of the Related Art

Heat exchangers with helical coil heat transfer tubes are used in various industries, including chemical engineering, heating, ventilating, and air conditioning (HVAC), refrigeration, and nuclear engineering, due to their geometric structure and enhanced heat transfer performance. In particular, as research and development for small and medium-sized reactors (SMRs) is actively progressing, studies on helical coil heat exchangers for application in these reactors are also being actively conducted. The convective heat transfer coefficient model of helical coil heat exchangers is one of the crucial factors in reactor design and safety assessment and other industrial applications. To predict the performance of helical coil heat exchangers, conventional models for analyzing straight tube heat exchangers or dedicated models that take into account the characteristics of helical coil heat exchangers are used. However, unlike straight tube heat exchangers or other type heat exchangers, the fluid inside helical coil heat exchangers experiences centrifugal force due to the spiral motion of fluid, making it difficult to accurately predict the performance of the helical coil heat exchangers using conventional models. Additionally, existing analysis models for helical coil heat exchangers are still not accurate enough, which presents challenges for their practical implementation. Therefore, there is a need for analysis models that adequately reflect the characteristics of helical coil heat exchangers to achieve improved accuracy.

The above description is information the inventor(s) acquired during the course of conceiving the present disclosure, or already possessed at the time, and was not necessarily publicly known before the present application was filed.

### SUMMARY

An object of an embodiment is to improve a boiling convective heat transfer coefficient model within a helical coil heat exchanger in order to enhance the prediction of convective heat transfer.

According to an aspect, there is provided a method of analyzing convective heat transfer, the method including calculating a parameter using a centrifugal force of a fluid flowing inside a heat exchanger and analyzing convective heat transfer performed inside the heat exchanger through a relational expression using the parameter.

In an embodiment, the parameter may be a first dimensionless number defined as centrifugal force relative to gravity of a fluid flowing inside the heat exchanger.

In an embodiment, the first dimensionless number may be calculated by a first equation, and the first equation may be

$${N}_{CF} = \frac{ρ {v}^{2} / {R}_{HC}}{ρ g} = \frac{{v}^{2}}{{gR}_{HC}} ,$$

wherein ρ denotes fluid density (kilogram per cubic meter (kg/m³)), v denotes a fluid velocity (meter per second (m/s)), g denotes gravity acceleration (meter per second squared (m/s²)), and R_{HC} denotes a radius (m) of a helical coil heat transfer tube of the heat exchanger.

In an embodiment, the first dimensionless number may be calculated based on a liquid component of the fluid.

In an embodiment, the first equation may be expressed by

$${N}_{CF , l} = \frac{{{G}^{2} ( 1 - x )}^{2}}{{α}_{l}^{2} {ρ}_{l}^{2} {gR}_{HC}} ,$$

wherein G denotes mass flux (kilogram per square meter per second (kg/m²s)), x denotes vapor quality, αₗ denotes a liquid volume fraction, ρₗ denotes liquid density (kg/m³), g denotes gravity acceleration (m/s²), and R_{HC} denotes a radius (m) of a helical coil heat transfer tube of the heat exchanger.

In an embodiment, the relational expression may further use a second dimensionless number, the second dimensionless number may be calculated by a second equation for a fluid flowing inside the heat exchanger, and the second equation may be expressed by

$${( \frac{1 - x}{x} )}^{0.8} {( \frac{{ρ}_{g}}{{ρ}_{l}} )}^{0.5} ,$$

wherein x denotes vapor quality, ρ_{g} denotes gas density (kilogram per cubic meter (kg/m³)), and ρₗ denotes liquid density (kg/m³).

In an embodiment, the relational expression may further use a third dimensionless number, the third dimensionless number may be calculated by a third equation for a fluid flowing inside the heat exchanger, and the third equation may be expressed by

$$\frac{q}{{Gh}_{fg}} ,$$

wherein q denotes heat flux (watt per square meter (W/m²)), G denotes mass flux (kilogram per square meter per second (kg/m²s)), and h_{fg} denotes latent heat of vaporization (Joule per kilogram (J/kg)).

In an embodiment, the relational expression may be

$$\frac{{h}_{TP}}{{h}_{l}} = {C}_{1} {{Co}^{{C}_{2}} ( 1 + 0.1 {N}_{CF , l} )}^{{C}_{3}} + {C}_{4} {Bo}^{{C}_{5}} + {C}_{6} ,$$

wherein h_{TP} denotes a two-phase flow convective heat transfer coefficient inside the heat exchanger, hₗ denotes a heat transfer coefficient calculated assuming single-phase liquid flow, N_{CF,l} denotes the first dimensionless number, Co denotes the second dimensionless number, Bo denotes the third dimensionless number, and C₁ to C₆ are constants.

In an embodiment, the heat exchanger may include a helical coil heat transfer tube or a straight heat transfer tube.

A non-transitory computer-readable storage medium may store instructions that, when executed by a processor, cause the processor to perform the method.

According to an aspect, there is provided an apparatus for analyzing convective heat transfer performed inside a heat exchanger, the apparatus including a memory configured to store one or more instructions and a processor configured to execute the one or more instructions, wherein, when the one or more instructions are executed, the processor may be configured to perform a plurality of operations, and wherein the plurality of operations may include calculating a parameter using a centrifugal force of a fluid flowing inside a heat exchanger and analyzing convective heat transfer performed inside the heat exchanger through a relational expression using the parameter.

Additional aspects of embodiments will be set forth in part in the description which follows and, in part, will be apparent from the description, or may be learned by practice of the disclosure.

According to an embodiment, a method, an apparatus, and a computer program for analyzing convective heat transfer occurring in a helical coil heat exchanger are provided. By utilizing the improved convective heat transfer coefficient model of the helical coil heat exchanger, convective heat transfer performance may be predicted more accurately.

According to an embodiment, a method, an apparatus, and a computer program for analyzing convective heat transfer occurring in a heat exchanger may predict not only the performance of a helical coil heat exchanger but also the performance of other type heat exchanger.

The effects of the method, apparatus, and computer program for analyzing convective heat transfer occurring in a heat exchanger are not limited to the above-mentioned effects, and other unmentioned effects may be clearly understood from the above description by those having ordinary skill in the technical field to which the present disclosure pertains.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a schematic view of a heat exchanger according to an embodiment;

FIG. 2 is a flowchart of a method of analyzing convective heat transfer, according to an embodiment;

FIG. 3 is a graph illustrating a correlation between a heat transfer modular ratio and a second dimensionless (convection number) based on experimental data shown in Table 1;

FIG. 4 is a graph illustrating a correlation between a heat transfer modular ratio and a third dimensionless number (boiling number) based on the experimental data shown in Table 1;

FIG. 5 is a graph illustrating a correlation between a heat transfer modular ratio and a first dimensionless number based on the experimental data shown in Table 1;

FIG. 6 is a graph illustrating a correlation between a heat transfer modular ratio, a second dimensionless number, and a first dimensionless number based on the experimental data shown in Table 1;

FIG. 7 is a surface plot graph illustrating a correlation between a heat transfer modular ratio, a second dimensionless number, and a first dimensionless number based on the experimental data shown in Table 1;

FIG. 8 is a graph illustrating a correlation between a measured heat transfer coefficient and a Froude number based on the experimental data shown in Table 1;

FIG. 9 is a graph comparing an actual measured result of the experimental data shown in Table 1 with an expected result according to a relational expression of the present disclosure;

FIG. 10 is a graph comparing experimental data on a helical coil heat transfer tube as shown in Table 1 and experimental data on a straight heat transfer tube as shown in Table 4 with a predicted result according to the relational expression of the present disclosure; and

FIG. 11 is an example of an apparatus for analyzing convective heat transfer occurring in a heat exchanger, according to an embodiment.

### DETAILED DESCRIPTION

The present application is based on and claims the priority of Korean Patent Application No. 10-2023-0106474, filed on Aug. 14, 2023, the entire disclosure of which is hereby incorporated by reference herein.

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. Terms, such as those defined in commonly used dictionaries, are to be interpreted as having a meaning that is consistent with their meaning in the context of the relevant art, and are not to be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, or the orders of the components are not limited by the terms. When one component is described as being “connected”, “coupled”, or “attached” to another component, it should be understood that one component may be connected or attached directly to another component, and an intervening component may also be “connected”, “coupled”, or “attached” to the components.

The same name may be used to describe an element included in the embodiments described above and an element having a common function. Unless stated otherwise, the description of an embodiment may be applicable to other embodiments, and a repeated description related thereto is omitted.

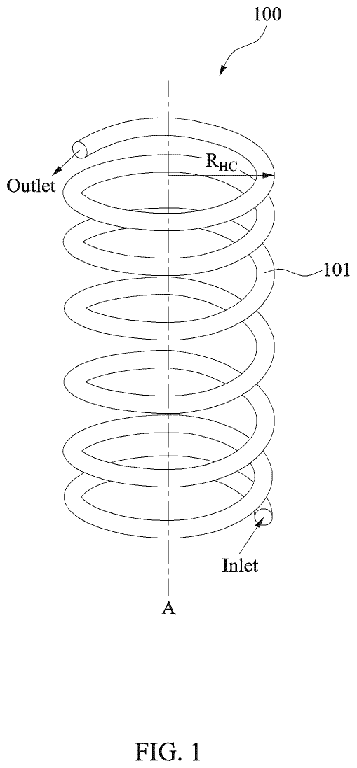

FIG. 1 is a schematic view of a heat exchanger according to an embodiment.

Referring to FIG. 1, a heat exchanger 100 according to an embodiment may be an apparatus for exchanging heat. For example, the heat exchanger 100 may be applied to a nuclear reactor (e.g., small and medium-sized nuclear reactors). For example, the heat exchanger 100 may include a helical coil heat transfer tube 101 and/or a straight heat transfer tube (not shown). For example, the helical coil heat transfer tube 101 may form a helical coil shape with a predetermined radius R_{HC} around the central axis A. A fluid inside the helical coil heat transfer tube 101 may exchange heat with an external space or an external fluid while flowing along the helical coil heat transfer tube 101.

For example, the heat exchanger 100 may perform heat exchange through boiling convective heat transfer. For two-phase flow, somewhat complex secondary flow may occur due to the centrifugal force according to the geometric shape of the helical coil heat transfer tube 101. For example, the fluid inside the helical coil heat transfer tube 101 may be affected by both gravity and centrifugal force. When two-phase flow occurs, a liquid, which is relatively denser than a gas, may be displaced towards relatively lower and outer sides due to gravity and centrifugal force. Due to such non-uniformity, the heat transfer characteristics of the helical coil heat transfer tube 101 may be more complex than those of a straight heat transfer tube. Therefore, it may be necessary to consider the influence of centrifugal force in the case of the helical coil heat transfer tube 101.

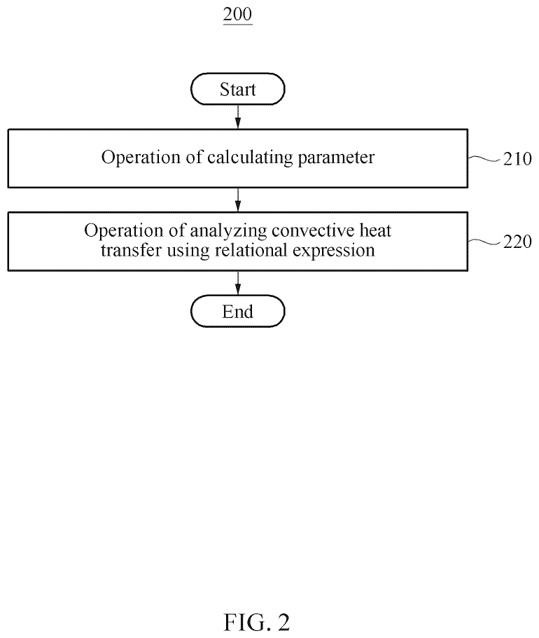

FIG. 2 is a flowchart of a method of analyzing convective heat transfer, according to an embodiment.

Referring to FIGS. 1 and 2, according to an embodiment, a method 200 of analyzing convective heat transfer may include operation 210 of calculating a parameter and operation 220 of analyzing the convective heat transfer using a relational expression. For example, a computer program according to an embodiment may be combined with hardware and stored in a computer-readable storage medium for executing the method 200 of analyzing convective heat transfer.

In an embodiment, operation 210 of calculating a parameter may be an operation of calculating a parameter using the centrifugal force of a fluid flowing inside the heat exchanger 100 (e.g., the helical coil heat transfer tube 101). For example, the parameter may be defined using the centrifugal force of the fluid. For example, the parameter may be a first dimensionless number defined as the centrifugal force relative to gravity of the fluid flowing inside the heat exchanger 100 (e.g., the helical coil heat transfer tube 101). However, this is only an example, and the parameter using the centrifugal force is not limited thereto. For example, the parameter may be a centrifugal force and may include a predetermined unit other than a dimensionless number.

In an embodiment, the first dimensionless number may be calculated by the First equation. The First equation may be an equation for dividing the centrifugal force of the fluid flowing inside the heat exchanger 100 (e.g., the helical coil heat transfer tube 101) by gravity. The First equation may be defined as follows. The first dimensionless number may be represented by N_{CF}.

First equation:

$${N}_{CF} = \frac{ρ {v}^{2} / {R}_{HC}}{ρ g} = \frac{{v}^{2}}{{gR}_{HC}}$$

In the First equation, ρ may denote fluid density (kilogram per cubic meter (kg/m³), v may denote a fluid velocity (meter per second (m/s)), g may denote gravity acceleration (meter per second squared (m/s²), and R_{HC} may denote the radius (m) of the helical coil heat transfer tube 101 of the heat exchanger 100.

In an embodiment, the first dimensionless number may be calculated using the First equation based on a liquid component of the components (e.g., a liquid and a gas) of the fluid flowing inside the heat exchanger 100 (e.g., the helical coil heat transfer tube 101). In this case, the First equation may be expressed as follows. The first dimensionless number calculated based on the liquid component of the fluid may be represented by N_{CF,l}.

First equation:

$${N}_{CF , l} = \frac{\frac{{ρ}_{l} {v}_{l}^{2}}{{R}_{HC}}}{{ρ}_{l} g} = \frac{{v}_{l}^{2}}{{gR}_{HC}} = \frac{{{G}^{2} ( 1 - x )}^{2}}{{α}_{l}^{2} {ρ}_{l}^{2} {gR}_{HC}}$$

In the First equation above, vₗ may denote a liquid velocity (m/s), G may denote mass flux (kilogram per square meter per second (kg/m²s), x may denote vapor quality, αₗ may denote a liquid volume fraction, ρₗ may denote liquid density (kg/m³), g may denote gravity acceleration (m/s²), and R_{HC} may denote the radius (m) of the helical coil heat transfer tube 101 of the heat exchanger 100.

In an embodiment, αₗ (liquid volume fraction) may be calculated by

$$\frac{( 1 - x ) ( \frac{{ρ}_{g}}{{ρ}_{l}} ) S}{x + ( 1 - x ) ( \frac{{ρ}_{g}}{{ρ}_{l}} ) S} .$$

Here, x may denote vapor quality, ρ_{g} may denote gas density (kg/m³), ρₗ may denote liquid density (kg/m³), and S may denote a slip ratio. S (slip ratio) may be v_{g}/vₗ defined as. Here, may denote a gas velocity (m/s) and vₗ may denote a liquid velocity (m/s). Based on the relationship between αₗ (liquid volume ratio) and S (slip ratio), First equation may be expressed as follows.

First equation:

$${N}_{CF , l} = \frac{{G}^{2}}{{gR}_{HC}} {( \frac{x}{{ρ}_{g}} \frac{1}{S} + \frac{1 - x}{{ρ}_{l}} )}^{2}$$

In the First equation, G may denote mass flux (kg/m²s), x may denote vapor quality, ρ_{g} may denote gas density (kg/m³), ρₗ may denote liquid density (kg/m³), g may denote gravity acceleration (m/s²), R_{HC} may denote the radius (m) of the helical coil heat transfer tube 101 of the heat exchanger 100, and S may denote a slip ratio. Here, S (slip ratio) may be calculated by being approximated to

$$max [ 1 , \sqrt{1 - x ( 1 - \frac{{ρ}_{l}}{{ρ}_{g}} )} ] .$$

αₗ (liquid volume fraction) may be modeled in various forms, and the description provided above is only an example.

In an embodiment, operation 240 of analyzing convective heat transfer using a relational expression may be an operation of analyzing convective heat transfer performed inside the heat exchanger 100 through a relational expression using the parameter described above. The relational expression may be an equation including a parameter at least using a centrifugal force. For example, the relational expression may be an equation using the first dimensionless number.

In an embodiment, the relational expression may include a parameter (e.g., the first dimensionless number) at least using the centrifugal force and further include other parameters (e.g., a second dimensionless number and/or a third dimensionless number).

In an embodiment, the relational expression may further use the second dimensionless number. The second dimensionless number may be calculated by the Second equation for the fluid flowing inside the heat exchanger 100 (e.g., the helical coil heat transfer tube 101). The Second equation may be defined as follows. The second dimensionless number may be represented by Co.

Second equation:

$$Co = {( \frac{1 - x}{x} )}^{0.8} {( \frac{{ρ}_{g}}{{ρ}_{l}} )}^{0.5}$$

In the Second equation, x may denote vapor quality, ρ_{g} may denote gas density (kg/m³), and ρₗ may denote liquid density (kg/m³). The second dimensionless number may be a convection number, which is a dimensionless number related to convection.

In an embodiment, the relational expression may further use a third dimensionless number. The third dimensionless number may be calculated by the Third equation for the fluid flowing inside the heat exchanger 100 (e.g., the helical coil heat transfer tube 101). The Third equation may be defined as follows. The third dimensionless number may be represented by Bo.

Third equation:

$$Bo = \frac{q}{{Gh}_{fg}}$$

In the Third equation, q may denote heat flux (watt per square meter (W/m²)), G may denote mass flux (kg/m²s), and h_{fg} may denote latent heat of vaporization (Joule per kilogram (J/kg)). The third dimensionless number may be a boiling number, which is a dimensionless number related to boiling.

In an embodiment, a relational expression, which is used to analyze convective heat transfer performed inside the heat exchanger 100, may use the first dimensionless number, the second dimensionless number, and the third dimensionless number as its parameters. For example, the relational expression may be expressed as follows.

Relational expression:

$$\frac{{h}_{TP}}{{h}_{l}} = {C}_{1} {{Co}^{{C}_{2}} ( 1 + 0.1 {N}_{CF , l} )}^{{C}_{3}} + {C}_{4} {Bo}^{{C}_{5}} + {C}_{6} ,$$

Here, N_{CF,l} may denote the first dimensionless number, Co may denote the second dimensionless number, Bo may denote the third dimensionless number, and C₁ to C₆ may denote constants. In addition, h_{TP} may denote a two-phase flow convective heat transfer coefficient inside the heat exchanger 100 (e.g., the helical coil heat transfer tube 101) and hₗ may denote a heat transfer coefficient calculated assuming single-phase liquid flow. For example, hₗ may be calculated using a Dittus-Boelter relational expression assuming single-phase liquid flow. C₁ to C₆ may be constants determined through an optimization process. For example, C₂, C₃, and C₅ may be constants representing gradient indices of log scales for the second dimensionless number Co, the first dimensionless number N_{CF,l}, and the third dimensionless number Bo, respectively. For example, C₆ may be a constant for compensating for the discontinuity of heat exchange between single-phase and two-phase. The basic structure of the relational expression described above may be based on a Kandlikar relational expression^{[1]} for saturated flow boiling. However, this is only an example, and a relational expression using the first dimensionless number, the second dimensionless number, and the third dimensionless number as its parameters is not limited to the relational expression described above. For example, a relational expression using the first dimensionless number, the second dimensionless number, and the third dimensionless number as its parameters may be set in various ways.

Hereinafter, through experimental data, it is described that using a method of analyzing convective heat transfer according to the present disclosure enhances the prediction accuracy of convective heat exchange performance of a heat exchanger.

First, to evaluate the method of analyzing convective heat transfer according to the present disclosure, seven sets of experimental data on a heat exchanger including a helical coil heat transfer tube are collected. The collected data is shown in Table 1 and includes a total of 624 data points.

TABLE 1

| | dᵢ | D_{HC}/ | P | Q | G | | Data |
|---|---|---|---|---|---|---|---|
| Investigator(s) | (mm) | dᵢ (—) | (MPa) | (kW/m²) | (kg/m²s) | Direction | points |
| Chang (2023) ^{[2]} | 8.0 | 81.3 | 8.0~14.0 | 100.0~300.0 | 500.0~1,000.0 | Vertical | 36 |
| Hardik (2017) ^{[3]} | 8.0/9.7 | 14.4/17.1 | 0.14~0.28 | 290.0~620.0 | 129.0~400.0 | | 41 |
| Owhadi (1966) ^{[4]} | 12.5 | 20.0/41.8 | 0.10~0.21 | 60.8~253.6 | 77.0~314.0 | | 235 |
| Santini (2016) ^{[5]} | 12.5 | 80.1 | 2.0~6.0 | 46.0~200.0 | 200.0~820.0 | | 60 |
| Xiao (2018) ^{[6, 7]} | 12.5/14.5 | 12.4/14.4/26.2/30.4 | 2.0~7.6 | 300.0~400.0 | 600.0~800.0 | | 23 |
| Xiao (2018) ^{[8]} | 14.5 | 12.4 | 2.0~7.6 | 200.0~500.0 | 400.0~1,000.0 | | 156 |
| Zhao (2003) ^{[9]} | 9.0 | 32.4 | 3.0 | 70.0~470.0 | 400.0~700.0 | Horizontal | 73 |

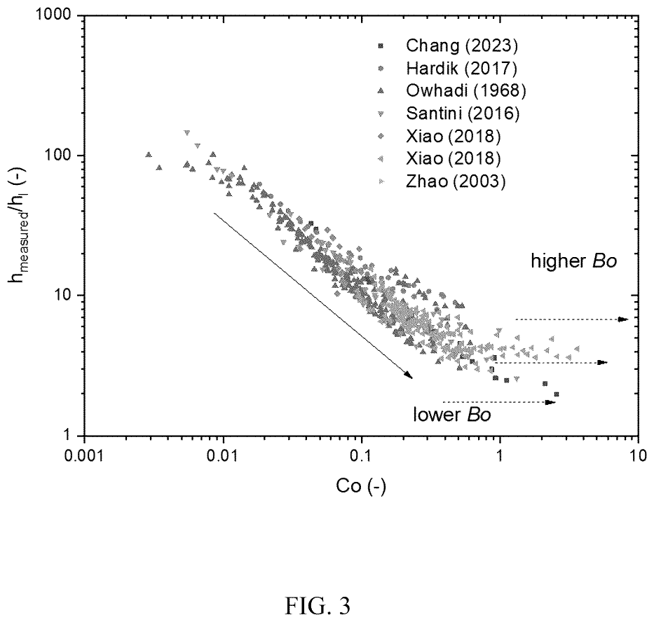

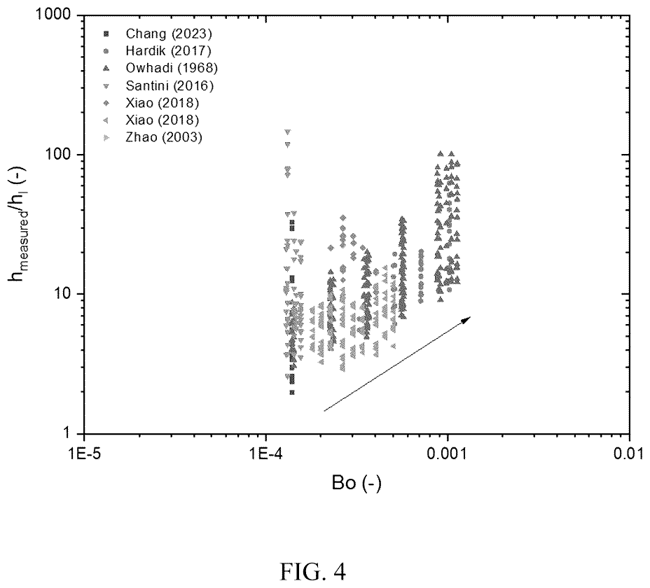

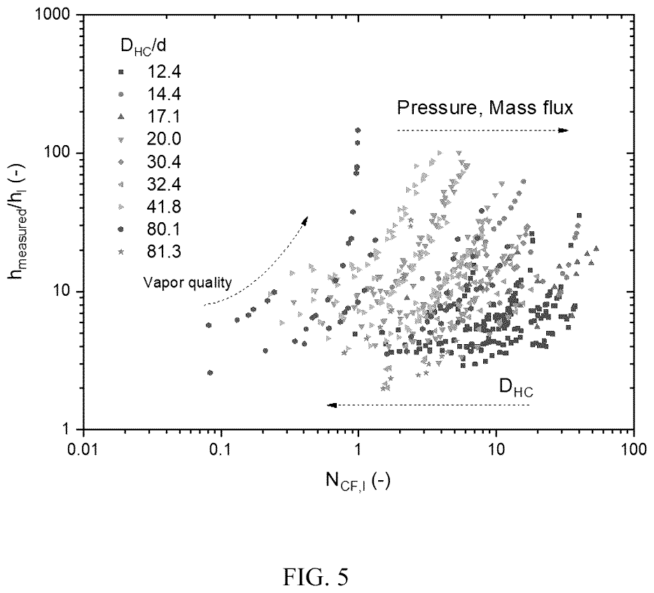

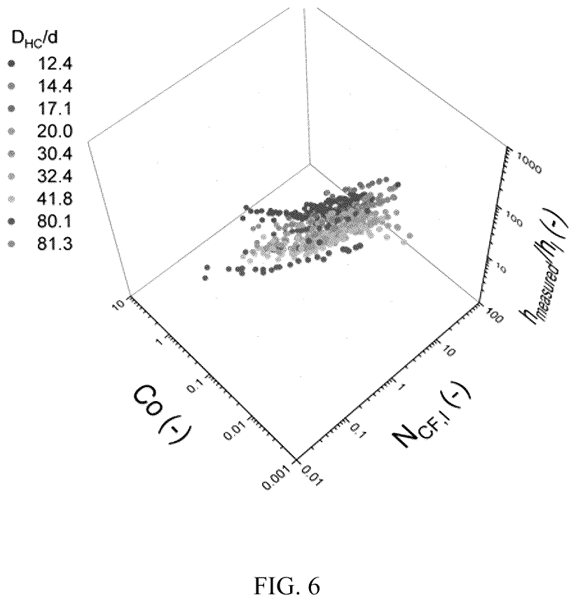

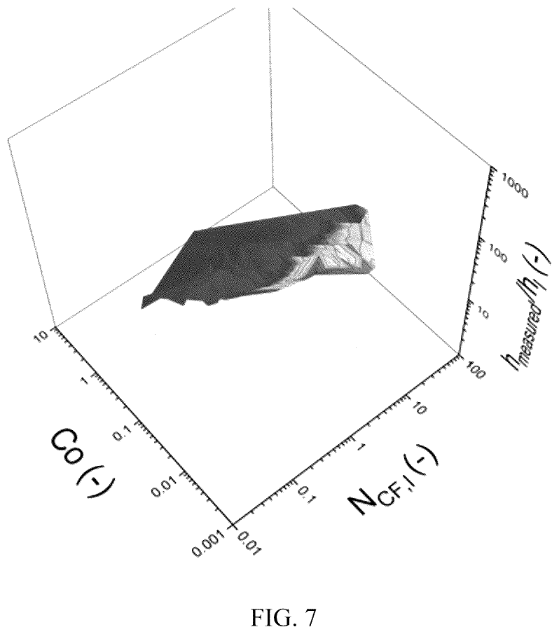

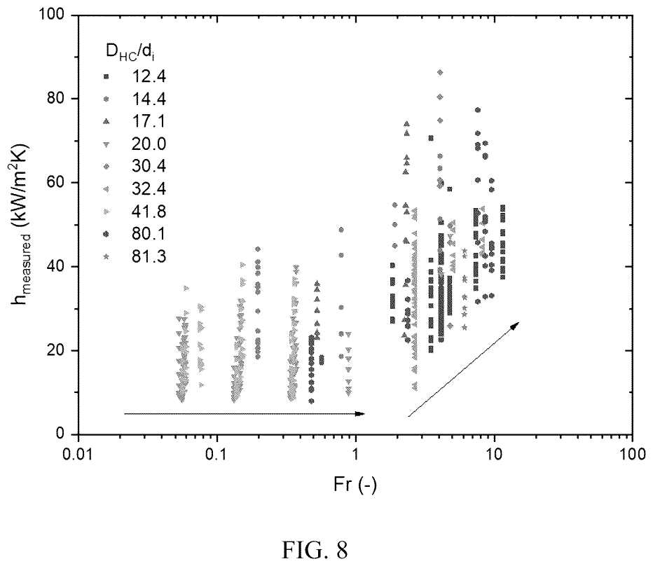

FIG. 3 is a graph illustrating a correlation between a heat transfer modular ratio and a second dimensionless number (convection number) based on the experimental data shown in Table 1. FIG. 4 is a graph illustrating a correlation between a heat transfer modular ratio and a third dimensionless number (boiling number) based on the experimental data shown in Table 1. FIG. 5 is a graph illustrating a correlation between a heat transfer modular ratio and a first dimensionless number based on the experimental data shown in Table 1. FIG. 6 is a graph illustrating a correlation between a heat transfer modular ratio, a second dimensionless number, and a first dimensionless number based on the experimental data shown in Table 1. FIG. 7 is a surface plot graph illustrating a correlation between a heat transfer modular ratio, a second dimensionless number, and a first dimensionless number based on the experimental data shown in Table 1. FIG. 8 is a graph illustrating a correlation between a measured heat transfer coefficient and a Froude number based on the experimental data shown in Table 1.

Referring to FIGS. 3 to 8, a heat transfer modular ratio may be obtained by dividing a measured two-phase heat transfer modular ratio h_{measured} by a single-phase heat transfer modular ratio hₗ calculated using a Dittus-Boelter relational expression. The first dimensionless number may be a dimensionless number defined as the centrifugal force relative to gravity of a fluid (e.g., liquid), the second dimensionless number may be a convection number, and the third dimensionless number may be a boiling number.

FIGS. 3 and 4 clearly illustrate that the heat transfer modular ratio correlates with each of the second dimensionless number Co and the third dimensionless number Bo. FIG. 3 illustrates that as the second dimensionless number Co increases, the heat transfer modular ratio decreases. When the second dimensionless number Co decreases (when vapor quality increases), the type of flow changes from bubbly flow to annular flow. In this case, convective boiling heat transfer becomes dominant, while nucleate boiling becomes relatively less effective. On the other hand, when the second dimensionless number Co increases (when vapor quality decreases), the nucleate boiling effect is pronounced, so heat transfer increases in proportion to the third dimensionless number Bo. These results demonstrate the dependency on the third dimensionless number Bo in a helical coil heat transfer tube.

FIG. 5 clearly illustrates that a heat transfer modular ratio correlates with a first dimensionless number N_{CF,l}. FIG. 5 illustrates that as the first dimensionless number N_{CF,l} increases, the heat transfer modular ratio increases, confirming that the heat transfer modular ratio depends significantly on centrifugal force. As the centrifugal force increases, a liquid membrane inside a helical coil heat transfer tube is distributed more evenly and a mixture is better blended, thereby improving boiling heat transfer. In addition, as vapor quality increases, the first dimensionless number N_{CF,l} increases and a heat transfer modular ratio gradually increases, thus supporting the dependency on the vapor quality. Compared to the dependency on the second dimensionless number Co, the trend of the heat transfer modular ratio with respect to the first dimensionless number N_{CF,l} may not converge to a single line. This is because the range of the first dimensionless number N_{CF,l} varies depending on factors such as mass flux, pressure, the radius of the helical coil heat transfer tube, and/or the like.

FIGS. 6 and 7 illustrate that a heat transfer modular ratio significantly depends on both the second dimensionless number Co and the first dimensionless number N_{CF,l}. Therefore, it may be possible to calculate the heat transfer modular ratio more precisely by considering both the second dimensionless number Co and the first dimensionless number N_{CF,l}.

FIG. 8 illustrates that a measured heat transfer modular ratio may remain with little fluctuation when a Froude number Fr is less than 1 and that the measured heat transfer modular ratio may gradually increase when the Froude number Fr is greater than 1. This may be described by the fact that the influence of gravity on inertia increases as the Froude number Fr decreases. As illustrated in FIG. 8, when the Froude number Fr is less than 1, the flow pattern of a helical coil heat transfer tube may be similar to the flow pattern of an inclined tube. As the influence of gravity increases, liquid membranes may accumulate at the bottom, thereby increasing non-uniformity of the temperature of the surrounding walls. Thus, despite the increase in the Froude number Fr, the increase in a heat transfer may become less sensitive. However, when the Froude number Fr is greater than 1, a warm current is intensified, promoting uniform flow and uniform wall temperature, and thus, as a mass flow rate increases, convective boiling heat transfer is enhanced due to a centrifugal force.

Table 2 shows the constants of relational expressions obtained by dividing the experimental data in Table 1 into two areas based on a point at which the Froude number Fr is one and fitting a curved line to each of the areas.

TABLE 2

| Constant | Fr < 1 | Fr ≥ 1 |
|---|---|---|
| C₁ | 0.66 | 0.97 |
| C₂ | −0.99 | −0.95 |
| C₃ | 0.103 | 0.0998 |
| C₄ | 3330.9 | 3427.6 |
| C₅ | 0.92 | 0.91 |
| C₆ | 1.40 | 0.55 |

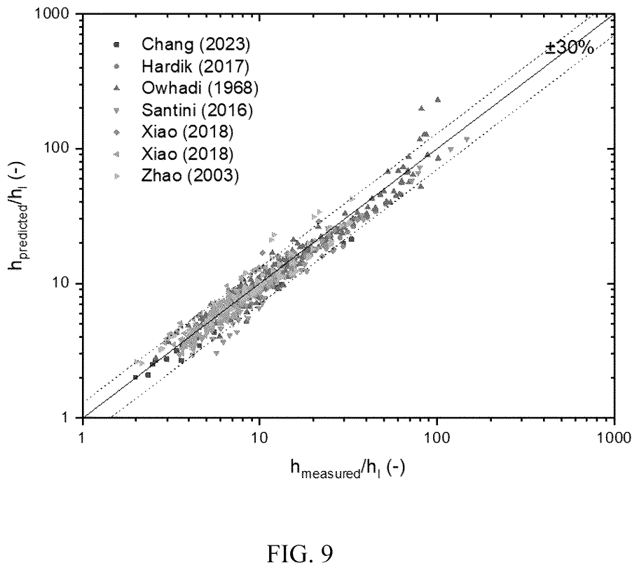

FIG. 9 is a graph comparing an actual measured result of the experimental data shown in Table 1 with a predicted result according to a relational expression of the present disclosure. In FIG. 9, the x-axis may be an actual measured result h_{measured}/hₗ according to the experimental data and the y-axis may be a predicted result h_{predicted}/hₗ according to the relational expression of the present disclosure.

Referring to FIG. 9, the actual measured result h_{measured}/h according to the experimental data significantly conforms to the predicted result h_{predicted}/hₗ according to the relational expression of the present disclosure. In other words, the relational expression shows an excellent predicted result.

For quantitative comparison, the previously known Kandlikar relational expression^{[1]}, the Shah relational expression^{[10]}, and the relational expression of the present disclosure are compared with one another in terms of root mean square error (RMSE), mean absolute error (MAE), and percentages within ±20% and ±30% bands. The results are shown in Table 3 below.

TABLE 3

| | Relational expression of | Kandlikar | Shah |
|---|---|---|---|
| | the present disclosure | (1990) ^{[1]} | (1976) ^{[10]} |
| RMSE (—) | 0.194 | 0.207 | 0.205 |
| MAE (—) | 0.141 | 0.161 | 0.159 |
| Data within ±20% | 75.79 | 67.66 | 69.80 |
| error band (%) | | | |
| Data within ±30% | 90.88 | 90.26 | 89.44 |
| error band (%) | | | |

Referring to FIG. 3, the predicted results according to the relational expression of the present disclosure may exhibit lower prediction errors than those of the predicted results according to the Kandlikar relational expression (1) and the Shah relational expression [10].

The relational expression of the present disclosure may be employed not only to predict the performance of a heat exchanger including a straight heat transfer tube but also to predict the performance of a heat exchanger including a helical coil heat transfer tube. For the straight heat transfer tube, in the relational expression of the present disclosure, the first dimensionless number N_{CF,l} may be set to be 0. To support this, six sets of experimental data on the heat exchanger including the straight heat transfer tube are collected. The collected data is shown in Table 4 and includes 2,012 data points.

TABLE 4

| | dᵢ | P | Q | G | | Data |
|---|---|---|---|---|---|---|
| Investigator(s) | (mm) | (MPa) | (kW/m²) | (kg/m²s) | Direction | points |
| Mumm (1954) ^{[11]} | 11.8 | 0.31~1.38 | 157.0~247.0 | 339.0~1,383.0 | Vertical | 343 |
| Sani (1960) ^{[12]} | 18.3 | 0.11~0.21 | 43.0~15.7 | 350.0~1,035.0 | | 254 |
| Schrock (1957) ^{[13]} | 3.0 | 0.29~1.27 | 306.0~2,090.0 | 1,245.0~2,939.0 | | 195 |
| Wright (1961) ^{[14]} | 18.2 | 0.10~0.35 | 4.74~157.0 | 250.0~1,345.0 | | 907 |
| Bennett (1976) ^{[15]} | 20.4 | 0.2 | 136.0~581.0 | 115.0~981.0 | Horizontal | 257 |
| Hardik (2016) ^{[16]} | 7.5/9.3/10.0 | 0.12~0.20 | 400.0~1,400.0 | 230.0~650.0 | | 56 |

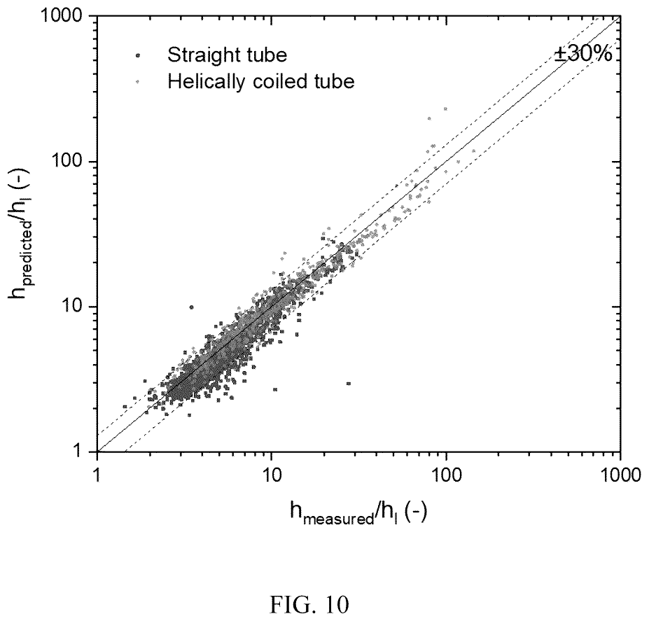

FIG. 10 is a graph comparing experimental data on a helical coil heat transfer tube as shown in Table 1 and experimental data on a straight heat transfer tube as shown in Table 4 with a predicted result according to the relational expression of the present disclosure. In FIG. 10, the x-axis may be the actual measured result h_{measured}/hₗ according to the experimental data and the y-axis may be the predicted result h_{predicted}/hₗ according to the relational expression of the present disclosure.

Referring to FIG. 10, it may be confirmed that the actual measured result h_{measured}/hₗ based on experimental data and the predicted result h_{predicted}/hₗ according to the relational expression of the present disclosure closely match not only in a helical coil heat transfer tube but also in a straight heat transfer tube. In the straight heat transfer tube, most of the experimental data is predicted within a ±30% error range, demonstrating the applicability of the relational expression of the present disclosure to both the helical coil and straight heat transfer tubes.

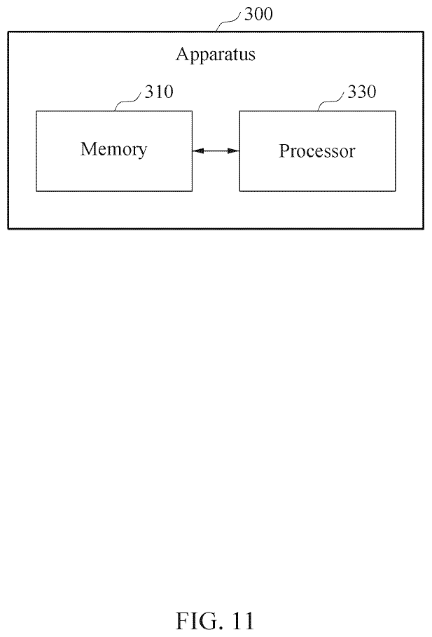

FIG. 11 illustrates an example of an apparatus for analyzing convective heat transfer occurring in a heat exchanger, according to an embodiment.

Referring to FIG. 11, an apparatus 300 may include a memory 310 and a processor 330.

The memory 310 may store instructions (e.g., a program) executable by the processor 330. For example, the instructions may include instructions for executing an operation of the processor 330 and/or instructions for executing an operation of each component of the processor 330.

The memory 310 may be implemented as a volatile memory device or a non-volatile memory device.

The volatile memory device may be implemented as dynamic random access memory (DRAM), static RAM (SRAM), thyristor RAM (T-RAM), zero capacitor RAM (Z-RAM), or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), a nano floating gate memory (NFGM), holographic memory, a molecular electronic memory device, or insulator resistance change memory.

The processor 330 may process data stored in a memory. The processor 330 may execute computer-readable code (e.g., software) stored in the memory 310 and instructions triggered by the processor 330.

The processor 330 may be a hardware-implemented data processing device having a circuit that is physically structured to execute desired operations. For example, the desired operations may include code or instructions in a program.

For example, the hardware-implemented data processing device may include a microprocessor, a central processing unit (CPU), a processor core, a multi-core processor, a multiprocessor, an application-specific integrated circuit (ASIC), and a field-programmable gate array (FPGA).

The method 200 of analyzing convective heat transfer of FIG. 2 may be stored in the memory 310 and executed by the processor 330 or embedded in the processor 330. The processor 330 may perform substantially the same operation as the method 200 of analyzing convective heat transfer of FIG. 2. Accordingly, a detailed description thereof is omitted.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, a FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or one or more combinations thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as floptical disks; and hardware devices that are specially configured to store and perform program instructions, such as ROM, RAM, flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the examples have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

Below are references to the known relational expressions and experimental data described in the present application.
[1] S. G. KANDLIKAR, “A general correlation for saturated two-phase flow boiling heat transfer inside horizontal and vertical tubes,” Journal of Heat Transfer-transactions, 112, 219 (1990); https://doi.org/10.1115/1.2910348.
[2] F. Chang et al., Experimental investigation on flow boiling heat transfer characteristics of water and circumferential wall temperature inhomogeneity in a helically coiled tube, Chemical Engineering Science, Vol. 272, pp 118592, 2023.
[3] B. K. Hardik and S. V. Parabhu, Boiling pressure drop and local heat transfer distribution of helical coils with water at low pressure, International Journal of Thermal Sciences, Vol. 114, pp. 44, 2017.
[4] A. Owhadi et al., Forced convection boiling inside helically-coiled tubes, International Journal of Heat and Mass Transfer, Vol. 11, pp. 1779, 1968.
[5] L. Santini et al., Flow boiling heat transfer in a helically coiled steam generator for nuclear power applications, International Journal of Heat and Mass Transfer, Vol. 92, pp. 91, 2016.
[6] Y. Xiao et al., Experimental investigation and prediction of post-dryout heat transfer for steam-water flow in helical coils, International Journal of Heat and Mass Transfer, Vol. 127, pp. 515, 2018.
[7] Y. Xiao et al., Experimental study on dryout characteristics of steam-water flow in vertical helical coils with small coil diameters, Nuclear Engineering and Design, Vol. 335, pp. 303, 2018.
[8] Y. Xiao et al., Experimental investigation of boiling heat transfer in helically coiled tubes at high pressure, Annals of Nuclear Energy, Vol. 113, pp. 409, 2018.
[9] L. Zhao et al., Convective boiling heat transfer and two-phase flow characteristics inside a small horizontal helically coiled tubing once-through steam generator, International Journal of Heat and Mass Transfer, Vol. 46, pp. 4779, 2003.
[10] M. M. SHAH, “Chart correlation for saturated boiling heat transfer: equations and further study,” ASHRAE Transactions, 88, 185 (1982).
[11] J. F. MUMM, Heat transfer to boiling water forced through a uniformly heated tube. Argonne National Laboratory, ANL-5276, 1954.
[12] R. L. SANI, Downflow boiling and nonboiling heat transfer in a uniformly heated tube, University of California, Lawrence Radiation Lab, UCRL-9032, 1960.
[13] V. E. SCHROCK and L. M. GROSSMAN, “Local heat transfer coefficients and pressure drop in forced convection boiling, University of California Radiation Laboratory, 73308-UCX-2182, 1959.
[14] R. M. WRIGHT, Downflow forced convection boiling of water in uniformly heated tubes, University of California, Lawrence Radiation Lab, UCRL-9744,1961.
[15] D. L. BENNETT, “A study of internal forced convective boiling heat transfer for binary mixture, Lehigh University, Ph.D. Thesis, 1948.
[16] B. K. HARDIK and S. V. PRABHU, Boiling pressure drop and local heat transfer distribution of water in horizontal straight tubes at low pressure, International Journal of Thermal Sciences, Vol. 110, pp. 65, 2016.

What is claimed is:

1. A method of analyzing convective heat transfer, the method comprising:
calculating a parameter using a centrifugal force of a fluid flowing inside a heat exchanger; and
analyzing convective heat transfer performed inside the heat exchanger through a relational expression using the parameter.

2. The method of claim 1, wherein the parameter is a first dimensionless number defined as centrifugal force relative to gravity of the fluid flowing inside the heat exchanger.

3. The method of claim 2, wherein
the first dimensionless number is calculated by a first equation, and
the first equation is
$${N}_{CF} = \frac{ρ {v}^{2} / {R}_{HC}}{ρ g} = \frac{{v}^{2}}{{gR}_{HC}} ,$$
wherein ρ denotes fluid density (kilogram per cubic meter (kg/m³)), v denotes a fluid velocity (meter per second (m/s)), g denotes gravity acceleration (meter per second squared (m/s²)), and R_{HC} denotes a radius (m) of a helical coil heat transfer tube of the heat exchanger.

4. The method of claim 3, wherein the first dimensionless number is calculated based on a liquid component of the fluid.

5. The method of claim 4, wherein the first equation is expressed by
$${N}_{CF , l} = \frac{{{G}^{2} ( 1 - x )}^{2}}{{α}_{l}^{2} {ρ}_{l}^{2} {gR}_{HC}} ,$$
wherein G denotes mass flux (kilogram per square meter per second (kg/m²s)), x denotes vapor quality, αₗ denotes a liquid volume fraction, ρₗ denotes liquid density (kg/m³), g denotes gravity acceleration (m/s²), and R_{HC} denotes a radius (m) of a helical coil heat transfer tube of the heat exchanger.

6. The method of claim 2, wherein
the relational expression further uses a second dimensionless number,
the second dimensionless number is calculated by a second equation for a fluid flowing inside the heat exchanger, and
the second equation is expressed by
$${( \frac{1 - x}{x} )}^{0.8} {( \frac{{ρ}_{g}}{{ρ}_{l}} )}^{0.5} ,$$
wherein x denotes vapor quality, ρ_{g} denotes gas density (kilogram per cubic meter (kg/m³)), and ρₗ denotes liquid density (kg/m³).

7. The method of claim 6, wherein
the relational expression further uses a third dimensionless number,
the third dimensionless number is calculated by a third equation for a fluid flowing inside the heat exchanger, and
the third equation is expressed by
$$\frac{q}{{Gh}_{fg}} ,$$
wherein q denotes heat flux (watt per square meter (W/m²)), G denotes mass flux (kilogram per square meter per second (kg/m²s)), and h_{fg} denotes latent heat of vaporization (Joule per kilogram (J/kg)).

8. The method of claim 7, wherein the relational expression is
$$\frac{{h}_{TP}}{{h}_{l}} = {C}_{1} {{Co}^{{C}_{2}} ( 1 + 0.1 {N}_{CF , l} )}^{{C}_{3}} + {C}_{4} {Bo}^{{C}_{5}} + {C}_{6} ,$$
wherein h_{TP} denotes a two-phase flow convective heat transfer coefficient inside the heat exchanger, hₗ denotes a heat transfer coefficient calculated assuming single-phase liquid flow, N_{CF,l} denotes the first dimensionless number, Co denotes the second dimensionless number, Bo denotes the third dimensionless number, and C₁ to C₆ are constants.

9. The method of claim 1, wherein the heat exchanger comprises a helical coil heat transfer tube or a straight heat transfer tube.

10. A non-transitory computer-readable storage medium storing instructions that, when executed by a processor, cause the processor to perform the method of claim 1.

11. An apparatus for analyzing convective heat transfer performed inside a heat exchanger, the apparatus comprising:
a memory configured to store one or more instructions; and
a processor configured to execute the one or more instructions,
wherein, when the one or more instructions are executed, the processor is configured to perform a plurality of operations, and
wherein the plurality of operations comprises:
calculating a parameter using a centrifugal force of a fluid flowing inside a heat exchanger; and
analyzing convective heat transfer performed inside the heat exchanger through a relational expression using the parameter.
